(19) United States
(12) Patent Application Publication
(10) Pub. No.: US 2021/0003258 A1
(43) Pub. Date: Jan. 7, 2021

(54) High-voltage Lamp String and System

(71) Applicant: Shangyou Jiayi Lighting Product Co., Ltd., Ganzhou (CN)

(72) Inventor: Yaowen HE, Ganzhou City (CN)

(21) Appl. No.: 16/918,732

(22) Filed: Jul. 1, 2020

(30) Foreign Application Priority Data
Jul. 2, 2019 (CN) 201921022655.3

(51) Int. Cl. F21S 4/10; F21V 31/04

(52) U.S. Cl. CPC F21S 4/10; F21V 3/02; F21V 31/04

(57) ABSTRACT

A high-voltage lamp string and a high-voltage lamp string system are provided. The high-voltage lamp string includes: a plurality of resistors, a plurality of lamp beads, a first conducting wire configured to conduct a current, a second conducting wire configured to conduct a current and a working wire for connecting the plurality of lamp beads in series; each of the plurality of resistors is connected between two respective adjacent wires among the three wires, and the first conducting wire and the second conducting wire are connected with a plug so as to turn on the plurality of lamp beads on the working wire after the plug is energized; and each of the plurality of lamp beads is encapsulated and fixed by glue with portions of the first conducting wire and the second conducting wire at the position corresponding to the lamp bead.

### CROSS REFERENCE TO RELATED APPLICATION

The present disclosure claims priority of Chinese Patent Application with the filing number 201921022655.3 filed on Jul. 2, 2019 with the Chinese Patent Office, and entitled “High-voltage Lamp String and System”, the contents of which are incorporated herein by reference in their entirety.

### TECHNICAL FIELD

The present disclosure relates to the technical field of illumination lamp strings, in particular to a high-voltage lamp string and a high-voltage lamp string system.

### BACKGROUND

The lamp bead in the prior art has the technical problems of poor contact caused by, e.g. oxidization and rusting of a contact surface due to long-term contact with ambient air.

### SUMMARY

Objects of the present disclosure include providing a high-voltage lamp string and a high-voltage lamp string system.

An embodiment of the present disclosure provides a high-voltage lamp string, including: a plurality of resistors, a plurality of lamp beads, a first conducting wire configured to conduct a current, a second conducting wire configured to conduct a current and a working wire for connecting the plurality of lamp beads in series; wherein each of the plurality of resistors is connected between two respective adjacent wires among the three wires, and the first conducting wire and the second conducting wire are connected with a plug so as to turn on the plurality of lamp beads on the working wire after the plug is energized;

In the above, each of the plurality of lamp beads is encapsulated and fixed with portions of the first conducting wire and the second conducting wire at a position corresponding to the lamp bead using glue.

An embodiment of the present disclosure provides a high-voltage lamp string system, including a plug and the above high-voltage lamp string, wherein the first conducting wire and the second conducting wire in the high-voltage lamp string are connected with the plug.

### BRIEF DESCRIPTION OF THE DRAWINGS

In order to more clearly illustrate embodiments of the present disclosure or technical solutions in the prior art, accompanying drawings which need to be used for description of the embodiments or the prior art will be introduced briefly below, and apparently, the accompanying drawings in the description below merely show some embodiments of the present disclosure, and those ordinarily skilled in the art still could obtain other relevant accompanying drawings in light of these accompanying drawings, without using creative effort.

FIG. 1 is a structural view of an existing high-voltage lamp string;

FIG. 2 is a circuit diagram of a high-voltage lamp string provided in an embodiment of the present disclosure; and

FIG. 3 is a structural view of a high-voltage lamp string provided in an embodiment of the present disclosure.

Reference signs: 1—external sleeve; 2—wire; 3—plastic part; 4—buckle; 110—resistor; 120—lamp bead; 130—first conducting wire; 140—second conducting wire; 150—working wire; 160—plug; 170—lampshade.

### DETAILED DESCRIPTION

Technical solutions of the present disclosure will be described below clearly and completely in connection with embodiments, and apparently, the embodiments described are only a part of embodiments of the present disclosure, rather than all embodiments. All other embodiments obtained by those ordinarily skilled in the art based on the embodiments of the present disclosure without using creative effort shall fall within the scope of protection of the present disclosure.

It should be indicated that terms “first”, “second” and so on in the description, the claims and the accompanying drawings of the present disclosure are used for distinguishing similar objects, rather than for describing a specific order or sequence. It should be understood that the data used in this way can be interchanged under appropriate circumstances, so that the embodiments of the present disclosure described herein can be implemented in an order other than those illustrated or described herein. Besides, terms “comprise”, “have” and any derivatives thereof are intended to cover non-exclusive inclusions, for example, a process, method, system, product or device that contains a series of steps or units is not necessarily limited to those steps or units expressly listed, but may include other steps or units not expressly listed or inherent to such process, method, product or device.

Herein, it also needs to indicate one point that in order to avoid obscuring the present disclosure with unnecessary detail, only device structures closely related to the solution according to the present disclosure is shown in the accompanying drawings, and other details not closely related to the present disclosure are omitted.

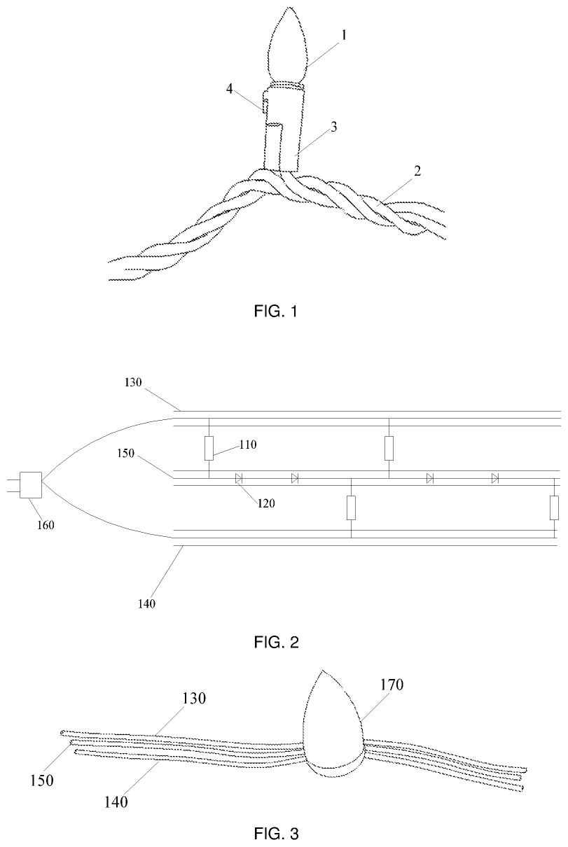

The LED lamp string has quite wide application, and can be applied to exterior decoration of buildings, interior decoration of rooms, decoration of parks, squares and so on. As shown in FIG. 1, lamp beads used in the existing LED high-voltage lamp string structure are all direct-insert lamp beads, and the lamp beads and wires are connected together in series by an external sleeve 1.

When making the current lamp beads, after a wire 2 is stripped, terminals and the wire 2 are pressed together by a tool, then the terminals are fixed at two sides inside a plastic part 3, the lamp bead passes through the plastic part 3, the deeper the lamp bead passes, the closer and tighter the contact is, and finally the lamp bead is snapped by a buckle 4 on the plastic part 3. The contact between the wire and the lamp bead is pressure contact. However, there may be a hole in the plastic part due to existence of structures such as the buckle, then long-term contact with ambient air will cause poor contact due to oxidation and rusting of a contact surface and so on.

In the existing lamp string structure, a connection portion between the wire and the lamp bead is wrapped by the plastic part 3, and is snapped by the buckle 4, but there may be a hole in the plastic part 3 due to existence of structures such as the buckle, then long-term contact with the ambient air will cause poor contact due to oxidation and rusting of a contact surface and so on.

Based on this, in a high-voltage lamp string and a high-voltage lamp string system provided in the present disclosure, the structure of the high-voltage lamp string includes: a plurality of resistors, a plurality of lamp beads, a first conducting wire configured to conduct a current, a second conducting wire configured to conduct a current and a working wire for connecting the plurality of lamp beads in series, wherein each of the plurality of resistors is connected between two respective adjacent wires, the first conducting wire and the second conducting wire are connected with a plug, each lamp bead is encapsulated and fixed by glue with the first conducting wire and the second conducting wire at positions corresponding to the lamp bead. Thanks to the above structure of the high-voltage lamp string, in the process of assembling a lampshade, the case of oxidation caused by long-term contact between a chip of an LED lamp bead and air can be relieved, the yield of the LED lamp beads manufactured can be improved, and meanwhile, the labor cost also can be reduced.

The present disclosure is described in detail below in combination with accompanying drawings.

FIG. 2 shows a high-voltage lamp string provided in the present disclosure, wherein the high-voltage lamp string includes: a plurality of resistors 110, a plurality of lamp beads 120, a first conducting wire 130 configured to conduct a current, a second conducting wire 140 configured to conduct a current and a working wire 150 configured to connect the plurality of lamp beads 120 in series.

Each of the plurality of resistors 110 is connected between two respective adjacent wires of the three wires, that is, connected between each the first conducting wire 130 and the working wire 150, or between the second conducting wire 140 and the working wire 150. In the above, the plurality of resistors 110 are configured to divide the voltage.

In the above, the first conducting wire 130 and the second conducting wire 140 are connected with the plug 160. After the plug 160 is plugged in, for example, the current on the first conducting wire 130 can be transmitted to the working wire 150 via the resistor between the first conducting wire 130 and the working wire 150, the lamp bead 120 can be turned on, and the current can be transmitted from the working wire 150 to the second conducting wire 140, via the resistor between the second conducting wire 140 and the working wire 150, so as to form a loop.

It should be indicated that the way of forming the loop is not merely restricted to the embodiment shown in FIG. 2, that is, the current passes through the first conducting wire 130, then passes through the working wire 150, and then flows back to the second conducting wire 140 to form the loop. There further may be other alterations according to connections of the lamp beads 120, for example, the current passes through the second conducting wire 140, then passes through the working wire 150, and then flows back to the first conducting wire 130 to form the loop.

Optionally, each of the plurality of lamp beads 120 is encapsulated and fixed by glue with the first conducting wire 130 and the second conducting wire 140 at positions corresponding to the lamp bead 120. In the above, the glue includes all types of encapsulation glue (or adhesive), for example, epoxy resin and silica gel. Besides, the first conducting wire 130 and the second conducting wire 140 also can be encapsulated and fixed with corresponding lamp beads 120 by a PVC injection molding process. As shown in FIG. 3, the first conducting wire 130, the second conducting wire 140 and the working wire 150 are arranged in parallel, at the position where the lamp bead 120 is connected with the working wire 150, the first conducting wire 130 and the second conducting wire 140 are in close proximity at the corresponding position, that is, the lamp bead 120 and portions of the first conducting wire 130 and the second conducting wire 140 which are in close proximity to the lamp bead 120 are encapsulated and fixed with each other. As the glue is airtight, no hole is present. The technical problem of the prior art lamp bead 120, i.e. poor contact caused by, e.g. oxidization and rusting of the contact surface due to long-term contact with ambient air, can be alleviated, so that the yield of the LED lamp beads 120 manufactured can be improved, and meanwhile, the labor cost also can be reduced.

Optionally, the plurality of resistors 110 are all installed between the first conducting wire 130 and the working wire 150, or the plurality of resistors 110 are all installed between the second conducting wire 140 and the working wire 150. Optionally, as shown in FIG. 2, some of the plurality of resistors 110 may be installed between the first conducting wire 130 and the working wire 150, and the rest of the plurality of resistors 110 may be installed between the second conducting wire 140 and the working wire 150. In the structure of the whole high-voltage lamp string, each resistor 110 can be encapsulated and fixed with corresponding portions of the first conducting wire 130 and the second conducting wire 140 at the place of the resistor 110.

As strong light is produced when the lamp bead 120 irradiates directly, as shown in FIG. 3, a lampshade 170 may be installed outside the lamp bead 120 that is already encapsulated and fixed, in this way, light from the lamp bead 120 can be prevented from directly irradiating into eyes which causes dizziness, meanwhile, the lamp bead 120 can also be protected against influence from the external environment, so as to prolong the service life of the lamp bead 120. In the above, the lampshade 170 may be in various shapes, for example, a spherical shape, a cubic shape, and a cylindrical shape.

In the above, each of the first conducting wire 130, the second conducting wire 140 and the working wire 150 may be a single-core wire or a multi-core wire.

When the first conducting wire 130, the second conducting wire 140 and the working wire 150 are single-core wires, the high-voltage lamp string may be relatively hard, and can be applied to surfaces of objects having a regular shape, or surfaces of objects that cannot deform, for example, to buildings having a relatively regular shape, roofs of buildings, and edges of buildings.

When the first conducting wire 130, the second conducting wire 140 and the working wire 150 are multi-core wires, the high-voltage lamp string may be softer, and can be applied to surfaces of objects having a relatively complex shape, or surfaces of objects that can deform, for example, on a robot's arm, wherein the soft high-voltage lamp string used on such movable arm is not prone to damage, or the high-voltage lamp string may be installed on a surface of an object such as a faucet, wherein as the shape of the faucet is relatively complex, the soft high-voltage lamp string used thereon is not prone to damage.

In order to avoid damage to the first conducting wire 130, the second conducting wire 140 and the working wire 150, in the present disclosure, a protection sleeve is provided on each of the first conducting wire 130, the second conducting wire 140 and the working wire 150. In this way, the first conducting wire 130, the second conducting wire 140 and the working wire 150 can be protected against damage, thus improving the service life of the three wires.

In the above, the material of the protection sleeves is an insulation material, for example, a plastic material, such as PVC (polyvinyl chloride).

Optionally, during practical manufacturing, it is also feasible to strip the protection sleeves of the first conducting wire 130 and the second conducting wire 140 at positions corresponding to the lamp bead 120, and encapsulate and fix each of the plurality of lamp beads 120 with portions of the first conducting wire 130 and the second conducting wire 140 at the position corresponding to the lamp bead 120 using glue.

The present disclosure further provides a high-voltage lamp string system, including a plug and any high-voltage lamp string described above, wherein the first conducting wire and the second conducting wire in the high-voltage lamp string are connected with the plug.

The high-voltage lamp string provided in the embodiment of the present disclosure has the same implementation principle of and technical effects produced as those in the above embodiment, and for the sake of concise description, reference can be made to corresponding contents in the above embodiment for contents which are not mentioned in the part of the embodiment of the high-voltage lamp string.

In the high-voltage lamp string system provided in the present disclosure, the structure of the high-voltage lamp string includes: a plurality of resistors, a plurality of lamp beads, the first conducting wire configured to conduct a current, the second conducting wire configured to conduct a current and the working wire for connecting the plurality of lamp beads in series, wherein each of the plurality of resistors is connected between two respective adjacent wires, the first conducting wire and the second conducting wire are connected with the plug, meanwhile, by encapsulating and fixing the lamp bead with portions of the first conducting wire and the second conducting wire at the position corresponding to the lamp bead using glue, in the process of assembling the lampshade, the chip of the LED lamp bead does not need to contact air for a long time, which causes oxidization, then the yield of the LED lamp beads manufactured can be improved, and meanwhile, the labor cost also can be reduced. Finally, it should be noted that the various embodiments above are merely used for illustrating the technical solutions of the present disclosure, rather than limiting the present disclosure; while the detailed description is made to the present disclosure with reference to the preceding embodiments, those ordinarily skilled in the art should understand that they still could modify the technical solutions disclosed in various preceding embodiments, or make equivalent substitutions to some or all of the technical features therein; and these modifications or substitutions do not make corresponding technical solutions essentially depart from the scope of the technical solutions of various embodiments of the present disclosure.

What is claimed is:

1. A high-voltage lamp string, comprising:
a plurality of resistors, a plurality of lamp beads, a first conducting wire configured to conduct a current, a second conducting wire configured to conduct a current and a working wire for connecting the plurality of lamp beads in series, wherein each of the plurality of resistors is connected between two respective adjacent wires among the three wires, and the first conducting wire and the second conducting wire are connected with a plug so as to turn on the plurality of lamp beads on the working wire after the plug is energized; and
each of the plurality of lamp beads is encapsulated and fixed by glue with portions of the first conducting wire and the second conducting wire at a position corresponding to the lamp bead.

2. The high-voltage lamp string according to claim 1, wherein the first conducting wire, the second conducting wire and the working wire are arranged in parallel, and at the position where each lamp bead is connected with the working wire, the first conducting wire and the second conducting wire are in close proximity.

3. The high-voltage lamp string according to claim 2, wherein each of the lamp beads is encapsulated and fixed by glue with the first conducting wire and the second conducting wire which are in close proximity to the lamp bead.

4. The high-voltage lamp string according to claim 1, wherein a lampshade is installed outside each lamp bead that is already encapsulated and fixed.

5. The high-voltage lamp string according to claim 1, wherein the plurality of resistors are all installed between the first conducting wire and the working wire; or the plurality of resistors are all installed between the second conducting wire and the working wire; or some of the plurality of resistors are installed between the first conducting wire and the working wire, and the rest of the plurality of resistors are installed between the second conducting wire and the working wire.

6. The high-voltage lamp string according to claim 2, wherein the plurality of resistors are all installed between the first conducting wire and the working wire; or the plurality of resistors are all installed between the second conducting wire and the working wire; or some of the plurality of resistors are installed between the first conducting wire and the working wire, and the rest of the plurality of resistors are installed between the second conducting wire and the working wire.

7. The high-voltage lamp string according to claim 3, wherein the plurality of resistors are all installed between the first conducting wire and the working wire; or the plurality of resistors are all installed between the second conducting wire and the working wire; or some of the plurality of resistors are installed between the first conducting wire and the working wire, and the rest of the plurality of resistors are installed between the second conducting wire and the working wire.

8. The high-voltage lamp string according to claim 5, wherein each of the resistors is encapsulated and fixed with corresponding portions of the first conducting wire and the second conducting wire at the position of the resistor.

9. The high-voltage lamp string according to claim 6, wherein each of the resistors is encapsulated and fixed with corresponding portions of the first conducting wire and the second conducting wire at the position of the resistor.

10. The high-voltage lamp string according to claim 7, wherein each of the resistors is encapsulated and fixed with corresponding portions of the first conducting wire and the second conducting wire at the position of the resistor.

11. The high-voltage lamp string according to claim 1, wherein each of the first conducting wire, the second conducting wire and the working wire is a single-core wire or a multi-core wire.

12. The high-voltage lamp string according to claim 1, wherein each of the first conducting wire, the second conducting wire and the working wire is provided with a protection sleeve.

13. The high-voltage lamp string according to claim 4, wherein each of the first conducting wire, the second conducting wire and the working wire is provided with a protection sleeve.

14. The high-voltage lamp string according to claim 5, wherein each of the first conducting wire, the second conducting wire and the working wire is provided with a protection sleeve.

15. The high-voltage lamp string according to claim 12, wherein the protection sleeves of the first conducting wire and the second conducting wire are stripped at a position corresponding to each of the lamp beads, each of the plurality of lamp beads is encapsulated and fixed by glue with portions of the first conducting wire and the second conducting wire at the position corresponding to the lamp bead.

16. The high-voltage lamp string according to claim 13, wherein the protection sleeves of the first conducting wire and the second conducting wire are stripped at a position corresponding to each of the lamp beads, each of the plurality of lamp beads is encapsulated and fixed by glue with portions of the first conducting wire and the second conducting wire at the position corresponding to the lamp bead.

17. The high-voltage lamp string according to claim 14, wherein the protection sleeves of the first conducting wire and the second conducting wire are stripped at a position corresponding to each of the lamp beads, each of the plurality of lamp beads is encapsulated and fixed by glue with portions of the first conducting wire and the second conducting wire at the position corresponding to the lamp bead.

18. The high-voltage lamp string according to claim 15, wherein a material of the protection sleeves is polyvinyl chloride material.

19. The high-voltage lamp string according to claim 16, wherein a material of the protection sleeves is polyvinyl chloride material.

20. A high-voltage lamp string system, comprising a plug and the high-voltage lamp string according to claim 1, wherein the first conducting wire and the second conducting wire in the high-voltage lamp string are connected with the plug.
